(19) United States
(12) Patent Application Publication
(10) Pub. No.: US 2024/0419126 A1
(43) Pub. Date: Dec. 19, 2024

(54) WINDING DEVICE FOR A HOROLOGICAL MOVEMENT OF A WATCH

(71) Applicant: The Swatch Group Research and Development Ltd, Marin (CH)

(72) Inventors: Jean-Jacques BORN, Morges (CH); Jérôme FAVRE, Neuchâtel (CH); Cédric NICOLAS, Neuchâtel (CH); Baptiste HINAUX, Lausanne (CH)

(73) Assignee: The Swatch Group Research and Development Ltd, Marin (CH)

(21) Appl. No.: 18/641,920

(22) Filed: Apr. 22, 2024

(30) Foreign Application Priority Data
Jun. 16, 2023 (EP) 23179858.8

(51) Int. Cl. G04D 7/00

(52) U.S. Cl. CPC G04D 7/009

(57) ABSTRACT

An apparatus (10) for winding a horological movement of a watch (20), including an electronic module (13) configured to control a motor (14) kinematically connected to a drive member intended to rotate a winding member of the watch (20). The apparatus (10) includes a support (11) for the watch (20) formed by a body having a central element (110) and at least one side element (111) arranged at a distance from each other so as to form a recess (118) intended to receive a strand (21) of a bracelet of the watch (20), the central element (110) and the side element (111) being adapted to apply opposing forces to the strand (21) so as to ensure that it is held in the recess (118).

### CROSS REFERENCE TO RELATED APPLICATION

This application claims priority to European Patent Application No. 23179858.8 filed Jun. 16, 2023, the entire contents of which are incorporated herein by reference.

### Technical Field of the Invention

The invention relates to the field of watchmaking and in particular to an apparatus for winding a horological movement of a watch.

The winding device is designed to wind a mechanical horological movement.

### Technological Background

Devices for winding a horological movement keep the movement running when the watch is not being worn by a user. To this end, during winding, these devices act, depending on the type of horological movement fitted to the watch, on the winding button or on the oscillating weight in order to tighten the mainspring. In particular, either the winding button is driven rotatably by a gripping member provided for this purpose, as described in document EP1220061, or the watch case is driven rotatably in order to pivot the oscillating weight, as described in document EP1489470.

All winding devices in the prior art require the watch whose movement is to be wound to be placed in a support provided for this purpose, ensuring that the watch is held in place during winding. This operation is typically relatively burdensome for the user.

To do this, a removable support, typically referred to as a “cushion”, must be extracted from a bed in the device by the user, the watch must then be manipulated so that its bracelet is closed around the support so that it is under tension, and then the support encircled by the watch must be put back into its bed.

Another drawback of existing winding devices is that the support is not adapted to all watch bracelet lengths, which is particularly detrimental for bracelets with folding clasps. In particular, if the bracelet is too short, it cannot be closed around the support, and if it is too long, it will not be tensioned by the support and the watch will not be held in position.

The purpose of this invention is to simplify the positioning of the watch in a winding device.

Another aim of the present invention is to allow the support to be easily adapted to any watch, regardless of bracelet length, so that the bracelet can be tensioned.

### SUMMARY OF THE INVENTION

To this end, the invention relates to an apparatus for winding a horological movement of a watch, which apparatus includes an electronic module configured to control a motor kinematically connected to a drive member intended to rotate a winding member of the watch. The apparatus includes a support for the watch connected to the drive member and formed by a body having a central element and at least one side element arranged at a distance from each other so as to form a recess intended to receive a strand of a bracelet of the watch, said central and side elements being adapted to apply opposing forces to said strand so as to ensure that it is held in said recess.

In particular embodiments, the invention can further include one or more of the following features, taken alone or in any combination technically possible.

In particular embodiments, the recess is defined by an inner flank of the side element, which inner flank has a concave cross-section and by an outer flank of the central element, which outer flank has a convex cross- section.

In particular embodiments, the central element is interposed between two side elements arranged relative to the central element so as to form two recesses each intended to receive one strand of a bracelet of the watch. The central element and the side elements are adapted to apply friction forces to said strands so as to hold them in said recesses.

In particular embodiments, the central element has an end referred to as the “rear end” opposite an end referred to as the “front end”, the front end of the central element being arranged between two facing ends of the side elements and being intended to receive a watch case bearing thereagainst.

In particular embodiments, the rear end has a greater capacity for elastic deformation when compressed than the front end.

In particular embodiments, the apparatus comprises a base on which the support is arranged, and the central element has a stop forming the rear end and being configured to be removably attached to the base so as to occupy at least two discrete positions in each of which the stop is arranged at a different distance from the front end.

In particular embodiments, the drive member is formed by a movable part of the base arranged in a cradle formed by a fixed part of the base. The fixed part has an internal volume in which the electronic module and the motor are housed, the movable part of the base being connected to the motor so as to be driven in a reciprocating rotary motion.

In particular embodiments, the drive member is formed by a connecting member intended to rotate a winding button of the watch in order to wind its horological movement.

### BRIEF DESCRIPTION OF THE FIGURES

Other features and advantages of the invention will become apparent from the following detailed description, which is given by way of example and is by no means limiting, with reference to the accompanying drawings in which:

FIG. 1 diagrammatically shows a perspective view of an apparatus for winding a horological movement of a watch according to a preferred embodiment of the invention, and of a watch inserted in this apparatus;

FIG. 2 diagrammatically shows a top view of a support of the apparatus of FIG. 1, comprising a central element having a rear end with a greater capacity for elastic deformation when compressed than a front end, the rear end being in the rest position;

FIG. 3 diagrammatically shows a top view of the support shown in FIG. 2, with the rear end being stressed by a bracelet of a watch arranged in the support;

FIG. 4 shows a perspective view of an apparatus as shown in FIG. 1, in which the support is arranged on a base comprising a plurality of holes for fastening a stop for the central element;

FIG. 5 shows a perspective view of the apparatus in FIG. 4, in which the stop is fastened to one of the holes in the base;

FIG. 6 diagrammatically shows a front view of the apparatus shown in FIG. 1, in which the base includes a movable part arranged so as to be rotatable in a cradle of a fixed part of said base;

FIG. 7 diagrammatically shows a front view of the apparatus according to another example embodiment of the invention, in which the apparatus includes a connecting member intended to rotate a winding button of the watch.

It should be noted that the figures are not necessarily drawn to scale for reasons of clarity.

### DETAILED DESCRIPTION OF THE INVENTION

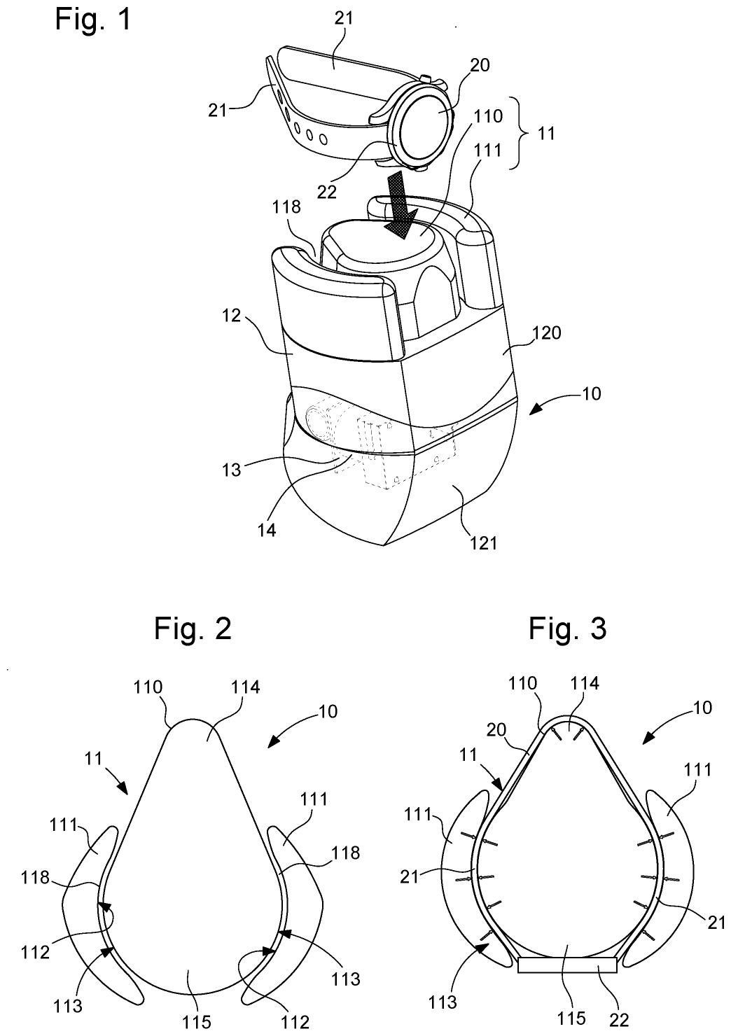

The invention relates to an apparatus 10 for winding a horological movement of a watch 20 as shown in FIG. 1 to 6 in a preferred example embodiment.

As shown in the figures, the apparatus 10 includes a support 11 for a watch 20, fastened to a base 12 and intended to hold the watch 20 whose horological movement is to be wound. The support 11 is formed by a body having a central element 110 and at least one side element 111 arranged at a distance from each other so as to form a recess 118 intended to receive a strand 21 of a bracelet of the watch 20. The recess 118 thus extends from the base 12, constituting a back of the recess 118, to an insertion opening through which a strand 21 is intended to be engaged in order to secure the watch 20 to the support 11.

More specifically, the central element 110 and side element 111 are adapted to apply opposing forces to said strand 21 so as to ensure that it is clamped in said recess 118. These forces are indicated by arrows in FIG. 3. In other words, the strand 21 is held in the recess 118, and thus in the support 11, by the friction forces resulting from the clamping forces to which it is subjected.

The recess 118 is defined, more precisely, by an inner flank 112 of the side element 111 and by an outer flank 113 of the central element 110. As shown in particular in FIGS. 2 and 3 in a preferred example embodiment of the invention, the inner flank 112 of the side element 111 has a concave cross-section and the outer flank 113 of the central element 110 has a convex cross-section. This arrangement generates more friction on the strand 21 engaged in the recess 118 and thus helps to better hold the watch 20 in position in the support 11.

The side element 111 is arranged either at a regular distance from the central element 110 so that the cross-section of the recess 118 is constant so that the forces to which the strand 21 is intended to be subjected are distributed thereover, or is arranged so as to generate a local zone in which the distance between the side element 111 and the central element 110 is minimal in order to locally generate a reduction in the cross-section of the recess 118 causing a concentration of stresses on said strand 21.

Preferably, the central element 110 is interposed between two side elements 111, as shown in FIG. 1 to 7, so as to hold in position two opposite strands 21 of the bracelet of the watch 20.

FIG. 1 shows in particular, by an arrow, the direction of engagement of the strands 21 of the watch 20 in the recesses 118, through the openings for inserting the strands 21, in order to fasten the watch 20 to the support 11.

The central element 110 preferably has an ovoidal cross-section and extends between two ends, one of which, referred to as the “rear end” 114, has a narrower shape than the other, referred to as the “front end” 115. The front end 115 is intended to support a case 22 of the watch 20, and in particular a back of the case 22, as shown in FIG. 1 and FIG. 3 to 7.

Advantageously, as can be seen in FIG. 1 and FIG. 3 to 7, the case 22 of the watch 20 is intended to rest in a space separating two facing ends of the side elements 111. This feature allows a user to observe, at any time, display members 23 of the watch 20 indicating a time value, such as the current time.

In the example embodiment of the invention shown in FIGS. 2 and 3, the rear end 114 has a greater capacity for elastic deformation than the front end 115 when they are compressed.

More specifically, the rear end 114 of the central element 110 has a relatively high elastic deformation capacity, and the front end 115 is substantially non-deformable. By way of illustration, FIG. 2 diagrammatically shows the rear end 114 and FIG. 3 diagrammatically shows the rear end 114 in a position under compressive stress from the bracelet of the watch 20. Thanks to the features of the invention in this example embodiment, installation of the watch 20 on the support 11 is very easy and the central element 110 can be adapted to any dimensions of the bracelet of the watch 20.

In particular, all that is required in order to install the watch 20 on the support 11 is to close the bracelet of the watch 20, then compress the rear end 114 of the central element 110 with the bracelet, and engage the strands 21 in each of the recesses 118 so as to cause the case 22 of the watch 20 to rest against the front end 115 of the central element 110, as shown in FIG. 3. Such an operation can advantageously be performed with one hand only. The watch 20 is thus held by the friction forces to which the strands 21 are subjected and by a resilient return force generated on the bracelet by the rear end 114 which tends to return to its rest position.

Thanks to the recesses 118 defined by the side elements 111 and the central element 110, it is also possible for the bracelet of the watch 20 to be left open, as shown in FIG. 1, in which case the watch 20 will only be held by the friction forces to which the strands 21 are subjected.

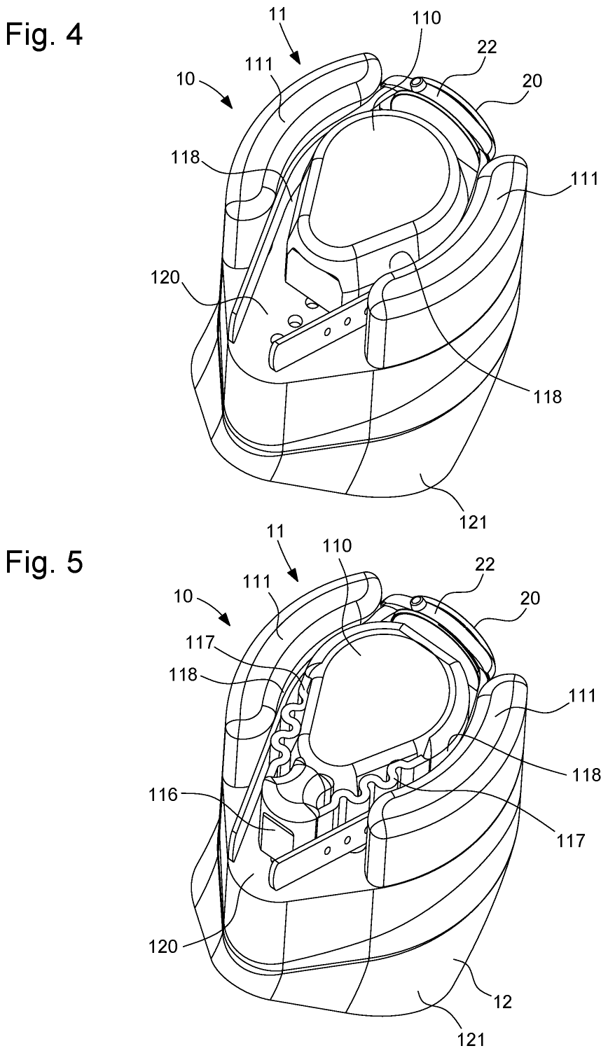

Alternatively, in the example embodiment of the invention shown in FIGS. 4 and 5, the central element 110 can include a stop 116 forming the rear end 114 and configured to be removably fastened to the base 12 so as to occupy at least two discrete positions. One of these discrete positions is further away from the front end 115 than the other. Thus, the support 11, and in particular the central element 110, can be adapted to any dimensions of the bracelet of the watch 20.

In a particular embodiment shown in FIG. 5, the stop 116 is connected by extending ties 117 to a fixed part of the central element 110 comprising the front end 115, as shown in FIG. 5. The extending ties 117 are arranged on either side of the central element 110 and are formed, for example, by elastically deformable strips of material having an undulating shape.

The stop 116 can be fastened to the base 12 by any suitable removable fastening solution. By way of example, the stop 116 can be provided with a pin intended to be engaged in one of a plurality of holes extending in the base 12, as shown in FIG. 4. In this case, the stop 116 can occupy as many positions as the base 12 has holes. In particular, in the example shown in FIG. 4, the base 12 has three holes arranged at different distances from the front end 115 of the central element 110, so the stop 116 can occupy three separate positions.

The watch 20 is installed on the support 11 in the same way as described above for the example embodiment of the invention shown in FIGS. 2 and 3. In other words, the bracelet is closed and then brought to bear against the stop 116, each of the strands 21 then being engaged in a recess 118 until the case 22 of the watch 20 is pressed against the front end 115 of the central element 110.

Similarly to the example embodiment of the invention shown in FIGS. 2 and 3, the bracelet of the watch 20 can be left open, in which case the watch 20 will only be held by the friction forces to which the strands 21 are subjected.

In all its example embodiments, the present invention thus ensures that the watch 20 is held in position in the support 11 during operation of the apparatus 10, regardless of the type of bracelet it comprises and regardless of the length of its bracelet.

Furthermore, when the watch 20 is installed in the support 11 with its bracelet closed, the latter is intended to be tensioned by the central element 110 insofar as the size of its periphery is variable, continuously in the case of the example embodiment shown in FIGS. 2 and 3, or discretely in the example embodiment shown in FIGS. 4 and 5. Thus, thanks to these features, the invention further guarantees that the watch is held in position during operation of the apparatus 10.

The base 12 defines an internal volume housing an electronic module 13, such as an integrated circuit, configured to drive a motor 14 kinematically connected to a drive member connected to the support 11 to rotate a winding member of the watch 20 in order to wind its horological movement.

In one example embodiment, the drive member of the winding apparatus 10 can be formed by a movable part 120 of the base 12, as shown in FIG. 1 and FIG. 4 to 6, said movable part 120 being intended to rotate an oscillating weight of the watch 20 in order to wind its horological movement.

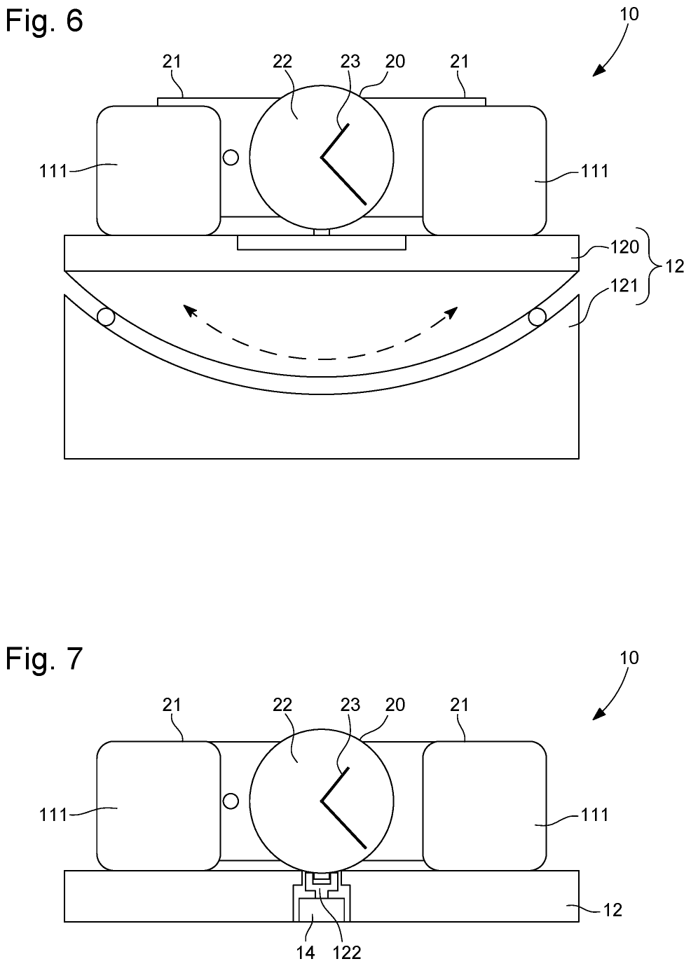

More specifically, the movable part 120 of the base 12 can be arranged in a cradle to which it has a complementary shape, the cradle being formed by a fixed part 121 of the base 12. The fixed part 121 has an internal volume in which the electronic module 13 and the motor 14 are housed. The movable part 120 can be driven by any suitable motion transmission solution as such within the reach of a person skilled in the art. In this example embodiment of the invention, the movable part 120 of the base 12 is driven in alternating rotation with an angular displacement of less than 180 degrees, preferably approximately 90 degrees, about an axis parallel to a central axis of the case 22 of the watch 20 when it is installed in the support 11, as seen in FIG. 6.

Alternatively, the drive member of the winding apparatus 10 can be formed by a connecting member 122, for example a bell, as shown in FIG. 7, intended to rotate a winding button of the watch 20 in order to wind its horological movement. In this case, it is clear that when the watch 20 is installed in the support 11, it must be positioned so that the winding button faces the base 12 in order to be able to cooperate with the bell.

More generally, it should be noted that the implementations and embodiments considered above have been described by way of non-limiting examples, and that other alternatives are thus conceivable.

In particular, the central element 110 can have a circular or elliptical cross-section, with the front end 115 and rear end 114 thus being of substantially identical dimensions. In general, the central element 110 can have a cross-section of any shape suitable for implementing the invention, in particular for generating the forces required to clamp the one or more strands 21 in the recesses 118.

Finally, the invention is compatible with subjecting the watch 20 installed in the support 11 to a periodic excitation oscillation of precise frequency, the electronic module 13 including for this purpose a rate measurement sensor arranged in the base 12, for example of the microphone type, intended to be in contact with the winding button of the watch 20 as shown diagrammatically in FIG. 6.

1. An apparatus (10) for winding a horological movement of a watch (20), including an electronic module (13) configured to control a motor (14) kinematically connected to a drive member intended to rotate a winding member of the watch (20), the apparatus (10) comprising:
a support (11) for the watch (20) formed by a body having a central element (110) and two side elements (111), the central element (110) being interposed between the two side elements (111) arranged relative to the central element (110) so as to form two recesses (118) each intended to receive a strand (21) of a bracelet of the watch (20),
said central element (110) and said side elements (111) being adapted to apply opposing forces to said strands (21) so as to ensure that they are held in said recesses (118), the central element (110) having a rear end (114) opposite a front end (115), the front end (115) being arranged between two facing ends of the side elements (111) and being intended to receive a case (22) of the watch (20) bearing thereagainst, the rear end (114) having a greater capacity for elastic deformation when compressed than the front end (115).

2. The apparatus (10) according to claim 1, wherein the recess (118) is defined by an inner flank (112) of the side element (111), which inner flank has a concave cross-section, and an outer flank (113) of the central element (110), which outer flank has a convex cross-section.

3. The apparatus (10) according to claim 1, wherein the drive member is formed by a movable part (120) of the base (12) arranged in a cradle formed by a fixed part (121) of the base (12), said fixed part (121) having an internal volume in which the electronic module (13) and the motor (14) are housed, the movable part (120) of the base (12) being connected to the motor (14) so as to be driven in a reciprocating rotary motion.

4. The apparatus (10) according to claim 1, wherein the drive member is formed by a connecting member (122) intended to rotate a winding button of the watch (20) in order to wind its horological movement.
